(19) United States
(12) Patent Application Publication
(10) Pub. No.: US 2015/0256589 A1
(43) Pub. Date: Sep. 10, 2015

(54) DATA PROCESSING SYSTEMS AND METHODS

(71) Applicant: PIERBRIDGE LIMITED, York (GB)

(72) Inventors: Mark Frank NEWBURN, Yorkshire (GB); Saana Pauliina LIIMATAINEN, Hull (GB); Robert Lawrence MALLEY, Southfield, MA (US)

(21) Appl. No.: 14/639,347

(22) Filed: Mar. 5, 2015

Related U.S. Application Data
(60) Provisional application No. 61/948,125, filed on Mar. 5, 2014.

(30) Foreign Application Priority Data
Mar. 5, 2014 (GB) 1403896.2

(51) Int. Cl. H04L 29/08

(52) U.S. Cl. CPC H04L 67/02; H04L 67/10

(57) ABSTRACT

Embodiments of the present invention relate to data processing systems and methods for supporting data source integration, such as, for example, real-time web-site modification within a preserved security context by using a substitute an IP address of a desired resource to redirect a request for that resource to a proxy that can provide any such integration.

The present application claims priority from UK patent application GB 1403896.2 and U.S. provisional application 61/948,125, both filed Mar. 5, 2014 and both of which are incorporated herein by reference for all purposes.

Embodiments of the present invention relate to data processing systems and methods.

Software as a Service (SaaS) solutions are an increasingly popular alternative to on-premise enterprise software deployments. SaaS has a number of advantages such as providing information technology (IT) services solutions and infrastructure in a cost effective and relatively swift manner. Furthermore, they allow businesses to concentrate their efforts on more strategic aspects of a business' IT needs.

However, SaaS solutions do not easily integrate and synchronise well with a business' incumbent enterprise information systems. Integration raises very significant security and data validation issues, as well as requiring custom programming to support integration and communication between one or more data sources or one or more services. Still further, a given SaaS solution offered by an external SaaS provider might meet the IT needs of one part of an organisation with little or no change, but might need a very considerable integration effort to meet the needs of a different part of the organisation in a manner that has to surmount any security or data validation issues.

One skilled in the art appreciates that services computing comprising, for example, web services integration, process integration and management, service oriented architecture etc. is a highly technical field. The prior art is replete with techniques directed to addressing integration and control issues. For example, browser extensions or plug-ins require an extension to a browser to be installed to achieve an enhanced browsing experience. Such extensions are platform-specific and browser-specific and need to be developed using a third-party framework, such as, for example, FireBreath, to achieve cross-browser capability, often involving client-side browser component installation.

Client-Side Proxy based platforms have traditionally been used for filtering and content monitoring, caching, protecting user privacy and modifying HTML content. However, client-side proxies suffer from network overheads and increased response times as can be appreciated from, for example, Viberg, T. “Client-Side Proxies—a better way to individualise the Internet?”, Stockholm: Department of Computer Sciences, Stockholm University, 2000. Furthermore, client-side proxy frameworks are neither extensible nor capable of providing a programming interface close enough to the content for integrating new functionality to static web-pages. Examples of widely used client-side proxies and content manipulation frameworks include Muffin, http://muffin.doit.org, and Scone, http://www.scone.de.

Mashup platforms provide a means for a user to compose web content, presentation and functionality on an ad hoc basis by integrating external data sources and services within a user interface. Mashup platforms allow dynamically created and tailored web-pages with on-demand access to data and other resources to be realised. One skilled in the art appreciates that content is served traditionally in the form of HTML or using some other mark-up protocols using data interchange formats such as JSON. Services and application functionality are often accessed through Application Programming Interfaces (APIs). Mashup platforms combine these building blocks either on the client-side in the browser or by using server-side languages such as PHP, Ruby, Java and C#. However, mashup platforms have the disadvantage of requiring low level development, which assumes an in-depth knowledge of data sources, APIs, data source schemes, programming language semantics and logic and conventions used for exchanging messages for each mashup scenario.

There are many mashup tools such as, for example, Google Mashup Editor or IBMQEDWiki, which support using and manipulating data feeds, as well as sorting and filtering. Custom data can be combined with an underlying presentation by either enhancing it with components such as popups or by directly modifying the underlying Document Object Model elements.

However, mashup platforms are constrained by rigid definitions of how data can be accessed and manipulated and are also platform and browser plug-in specific.

Furthermore, mashup platforms can only operate within hosted environments, which make them unsuitable for adapting legacy processes and systems. Significantly, mashup tools require creation of a new domain and therefore do not account for cross-domain data security considerations. Still further, a mashup does not provide for data validation and authentication and does not provide for user interfaces that can be abstracted and re-used on a number of web-sites with customisable data and service models.

Finally, composite application development platforms, like mashup platforms, provide a means for developing applications from integrated data sources, web content and services. Examples of composite application development platforms are Cordy's Process Factory, http://www.cordys.com/process_factory, and InterSystems Ensemble, available from InterSystems Corporation. However, where mashup platforms modify existing web sites, composite applications create new functionality and do not re-use or repurpose external web-pages.

Integration efforts and the like such as web-page modification or augmentation can give rise to security exceptions such as, for example, violations of a Same-Origin Policy or some other browser related security issue. An example of the use of a plug-in or browser extension is given in US2008/0222736. However, one skilled in the art appreciates that a redirector as disclosed therein, especially if realised in the form of a WinInet API will raise security exceptions. Alternative forms of the redirector disclosed therein are burdened with the need for at least one browser or platform specific plug-ins, which is burdensome for one skilled in the art and undesirable. Furthermore, hooking HTTP/HTTPS requests with custom applications using lower level protocol APIs

, such as WinInet or WinHTTP, is undesirable since one skilled in the art appreciates that such APIs are used for various nefarious applications such as, for example, Trojans or other Man-in-the-Middle type attacks. Still further, such APIs are very platform dependent and limited to Windows.

Embodiments of the present invention address one or more of the above problems.

Accordingly, embodiments of the present invention provide a data processing system, comprising an operating system database, preferably a HOSTS file, adapted to map a first representation of a URL or URI having a first associated IP address to a substitute IP address; the substitute IP address being associated with a proxy server; the first representation of the URL or URI having the first associated IP address being within a respective security context of a browser adapted for accessing a first resource, via the first associated IP address, the first resource being accessible by a first respective server; the database being external to the respective security context of the browser, and the proxy server being adapted to retrieve the first resource via the first associated IP address and to at least modify the retrieved first resource, the proxy server being further adapted to output the modified first resource for processing by the browser preserving the security context of the first browser.

Advantageously, embodiments provide a web-services integration platform to seamlessly integrate at least one or more than one of disparate data sources, web-content and SaaS applications and facilitate adapting the same to meet a defined role or process taken jointly and severally in any and all permutations. Suitably, any such integration can be achieved without compromising security or at least without having a browser that is used for any such integration raising security exceptions or failing work as intended due to such security exceptions such as, for example, domain or URL redirections or forwarding exceptions, as may be encountered in various and often nefarious situations such as phishing.

Still further, embodiments provide methods for integrating at least one of data and services into a web-page from a number of sources without needing to install browser extensions or other platform specific client components.

Embodiments provide methods for augmenting web-site content within a platform for integrating third party data, web content or business processes to SaaS solutions.

Phishing is a very serious security concern. It is estimated, by, for example, The Gartner group, that direct phishing related losses to US banks and credit card issuers amount to over $1 billion per annum. Consequently, considerable effort is directed to preventing phishing, which includes addressing and preventing redirection and other security breaches of a browser's security context.

Therefore, embodiments can be realised that support augmenting a third party web-page, for example, with additional content, data, scripts etc. without causing a redirection exception that is typically associated with automatic redirection that is normally used in any such augmenting. In particular, methods are provided for addressing network nodes for directing HTTP and HTTPS traffic to a reverse proxy server that preserves a user or browser security context in a platform-independent and browser-independent manner.

Embodiments of the invention are further described herein, by way of example, with reference to the accompanying drawings, in which:

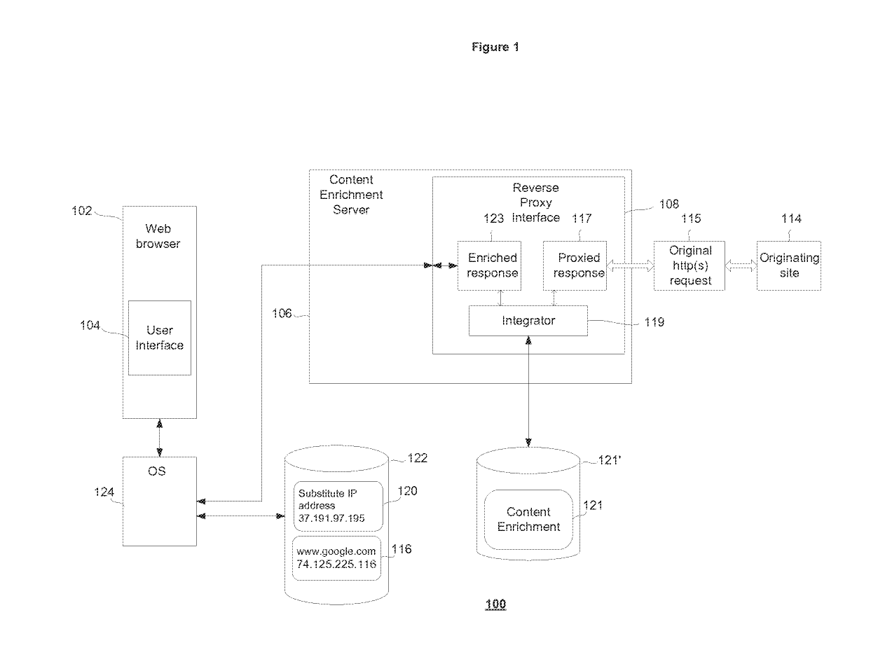

FIG. 1 shows an embodiment of a data processing system;

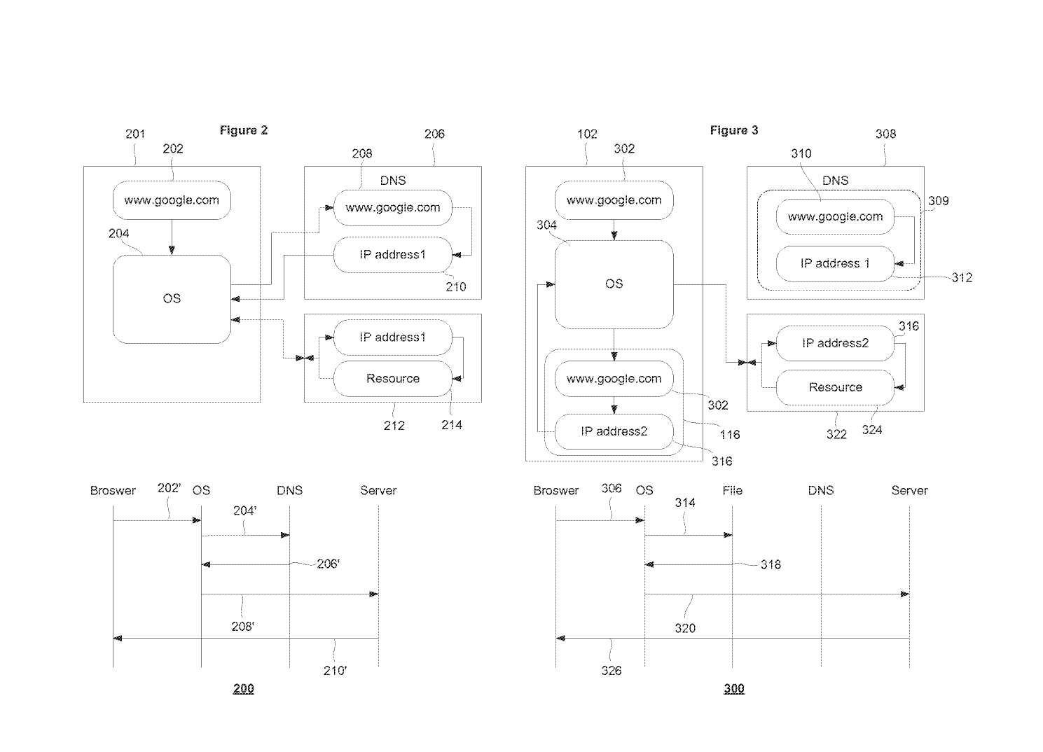

FIG. 2 illustrates URL processing according to the prior art;

FIG. 3 depicts URL processing according to an embodiment;

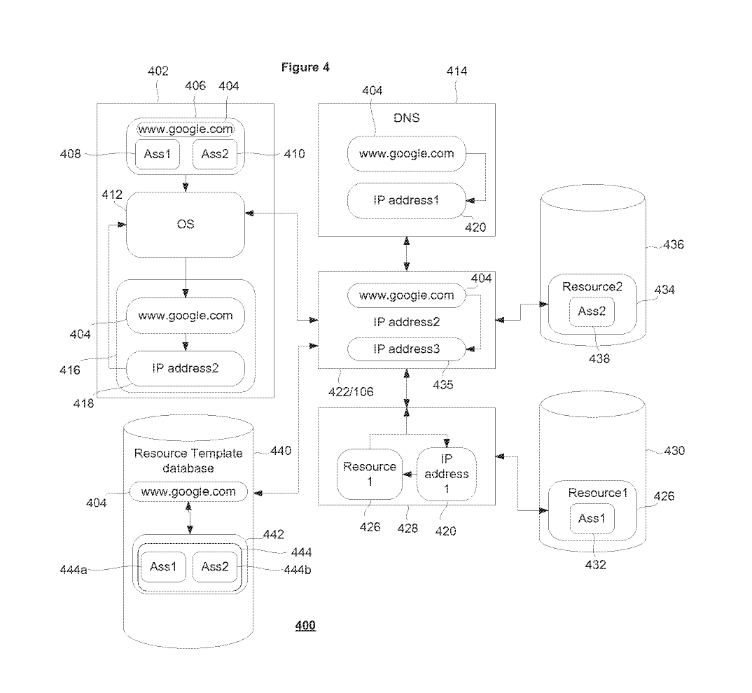

FIG. 4 shows web-page modification according to an embodiment;

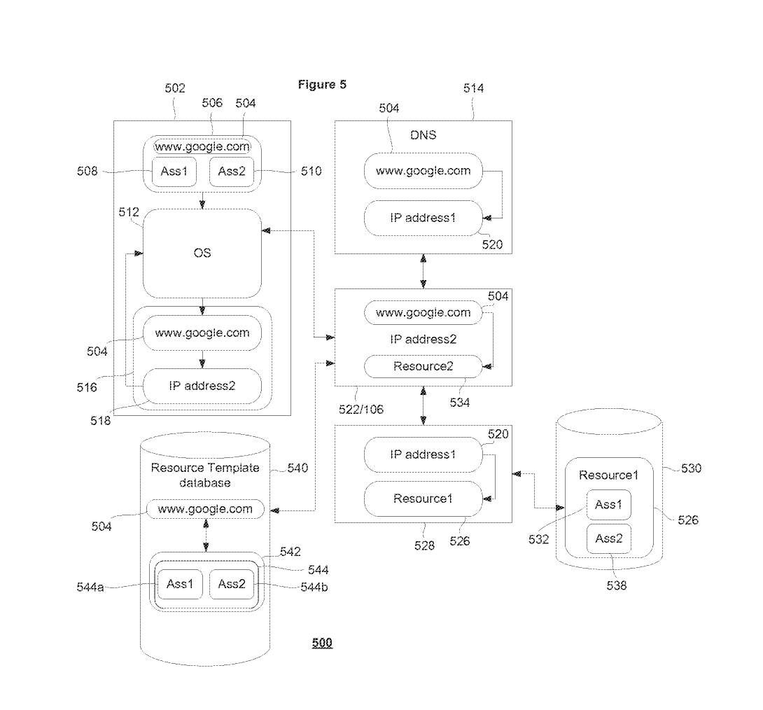

FIG. 5 illustrates web-page modification according to an embodiment;

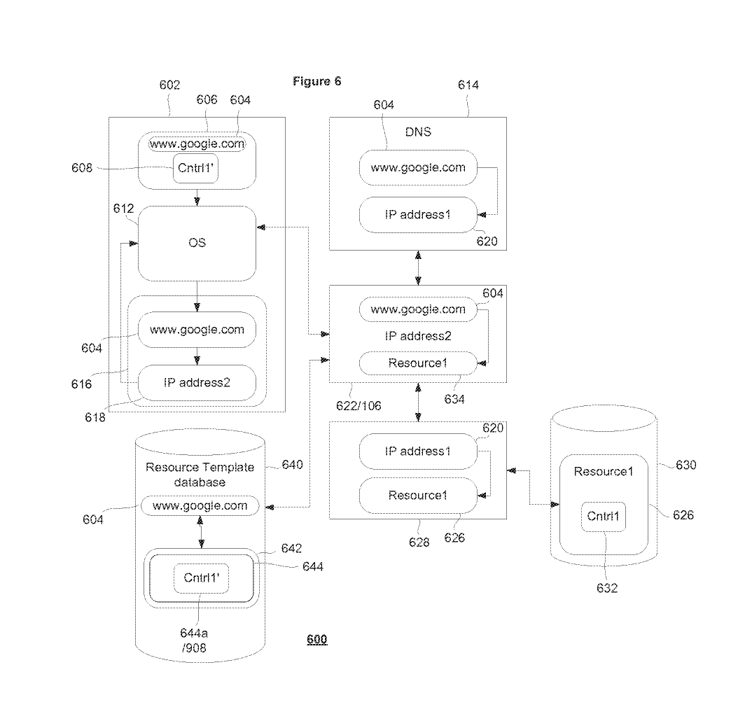

FIG. 6 depicts web-page controls modification according to an embodiment;

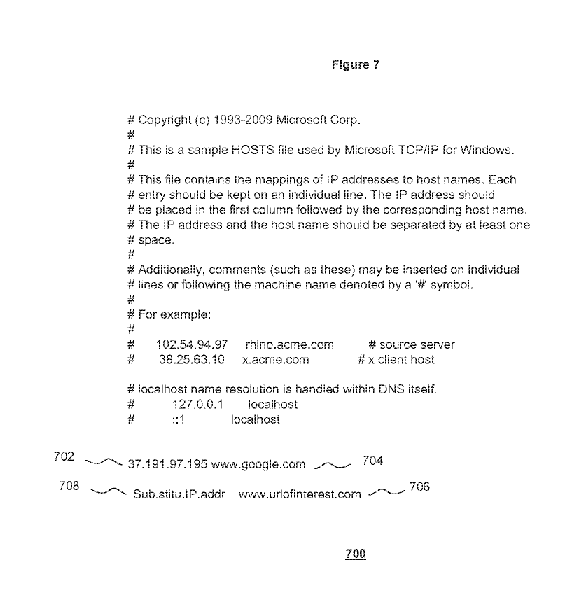

FIG. 7 shows an embodiment of a hosts file;

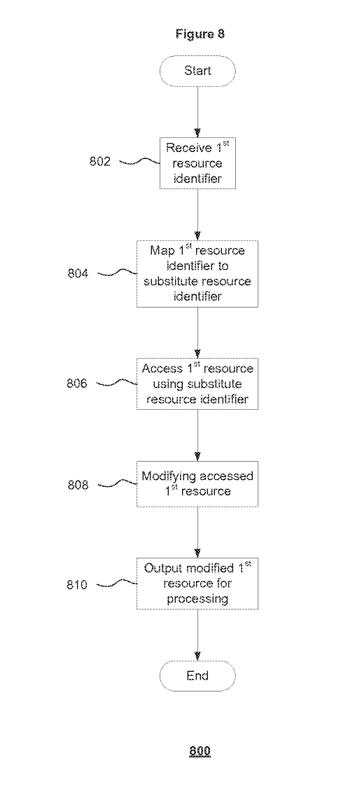

FIG. 8 illustrates a flowchart according to an embodiment;

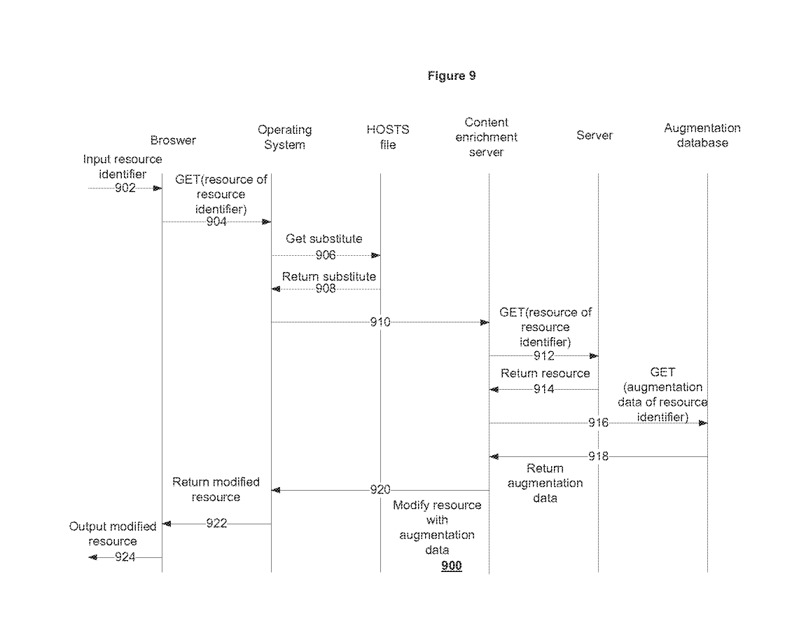

FIG. 9 depicts a flowchart according to an embodiment; and

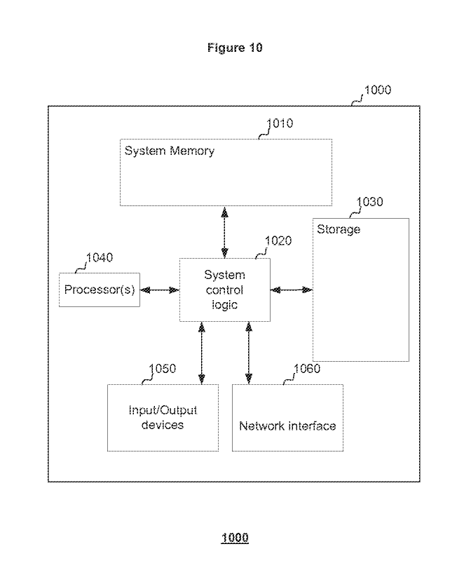

FIG. 10 shows a data processing system according to an embodiment.

Referring to FIG. 1, there is shown an embodiment of a data processing system 100. The data processing system 100 comprises a web browser 102 for presenting a user interface 104 to a user (not shown). The user interface 104 is presented using associated code, preferably in the form of a rendered mark-up language such as, for example, hypertext or a similar document or documents. The associated code is obtained from a server, known as a content enrichment server 106. The content enrichment server 106 is configured as a reverse proxy server as will be described hereafter.

The content enrichment server 106 can comprise one or more than one interface. In the embodiment shown, a reverse proxy interface 108 is provided. The reverse proxy interface 108 enables the content enrichment server 106 to operate as a reverse proxy server.

The reverse proxy interface 108 is an interface to software 119 that is operable to augment web-content returned from a web-server 114 in response to a browser request or traffic before returning the augmented content to the browser 102 for rendering. The reverse proxy interface 108 is capable of handling any synchronous post back messages or asynchronous call-back messages to ensure that any data, events or other web-content can be identified and modified prior to being returned to the browser 102 for rendering.

One skilled in the art will appreciate that typically redirecting a request to a proxy server or server other than the one specified by the browser 102 would normally give rise to a security issue or exception. Embodiments address this problem, that is, maintain the user security context without compromising browser-independence, by ensuring that any network node addressing is achieved by mapping domain names of interest issued by or used by the browser 102 to the IP address of the reverse proxy interface 108 within a mapping file 116 that maps a given URL, which can be in text form, to a stated or substitute IP address 120. The substitute IP address 120 is the IP address of the reverse proxy interface 108 or content enrichment server 106 rather than being the IP address ordinarily associated with a given domain name, as would be registered with an accredited Domain Name Server (DNS) registry.

One skilled in the art will appreciate that a browser's security context comprises, or defines, operations that do not give rise to a browser security exception. Such operations are said to be within the security context of the browser whereas operations that do give rise to a browser security exception are said to be outside, or without, the security context of the browser. For example, the security context of a browser can be defined by a set of permissions. The set of permissions define the actions, or operations, that a browser is allowed to perform, or to accommodate. Such actions, or operations, that a browser is allowed to perform, or to accommodate, are said to be within the browser's security context and do not give rise to a browser security exception. All other actions, or operations, that do not comply with the set of permissions are said to be outside of the browser's security context and do give rise to a browser security exception. Examples of breaches of a security context comprise, for example, breaches of a Same-origin policy or breaches of network or connection related security policies. One skilled in the art will appreciate that a user security context exists within the scope of a user agent browsing context that is tied to a browsing session with the underlying principle being to provide unrestrained scripting and other interactions between pages served as part of the same site, that is, having a particular DNS host name or part thereof) whilst at least influencing, preferably preventing, any interference between unrelated sites.

In the embodiment shown, the mapping file 116 is shown as mapping www.google.com, which usually has an IP address of, for example, 74.125.225.116, to the reverse proxy server 106, which is shown as having a substitute IP address 120 of 37.191.97.195. One skilled in the art will appreciate that the mapping file 116 is provisioned with one or more than one mapping that points one or more than one URL of interest to the reverse proxy server. It will be appreciated that such provisioning will be undertaken in advance of any attempted access to the IP address. In effect, the IP address mapped to the domain name is a substitute IP address, that is, it is an IP address that is not related to the domain name from the perspective of an accredited domain name registrar. A list of accredited DNS registrars is available at, for example, InterNIC and ICANN. The mapping file 116 is typically accessible to a supporting operating system 124 via respective storage 122.

By ensuring that network node addressing is achieved by the above mapping of a domain name or URL to a substitute IP address, there is no need for platform-specific DNS client service components. Furthermore, since all traffic from the perspective of the browser passes through or is associated with the original URL and since there is no need for URL rewrites ensuring cross-site authentication, using, for example a Security Assertion Markup Language, and other functionality requiring POSTs to other domains, the redirection to the substitute IP address works correctly, that is, works without raising a security exception.

It can be appreciated that the browser 102 issues a request to the operating system 124 to connect to a given IP address. The given IP address has an associated security context. For example, the browser may operate a Same Origin policy under which any response to a request for information must be met with a response preserving that security context. The protocol, host and port, taken jointly and severally in any and all permutations, must be preserved, that is, the response must have the same origin as that to which the request for information was sent. The operating system 124, via the mapping file 116, maps the given IP address to the substitute IP address 120, and includes the given IP address in any communication with the reverse proxy server 106.

The reverse proxy server 106 retrieves the web-content (not shown) from a server or originating site 114 associated with the given IP address via a conventional HTTP request 115 and the proxied response 117 is processed by the software component 119 to augment or otherwise modify the proxied response 117 with content 121 accessible to the software component 119, which hereinafter will be referred to as an integrator 119, via respective storage 121′. The augmented or modified proxied response, known as an enriched response 123, is then passed back to the operating system 124 and ultimately to the browser 102 for rendering.

Although the embodiment illustrated shows a mapping file 116 having a single URL to substitute IP address mapping, embodiments can be realised in which other URLs are mapped to the reverse proxy server 108. Additionally, or alternatively, one or more of the other URLs could be mapped to respective reverse proxy servers. Therefore, embodiments are provided that use a plurality of such reverse proxy servers.

FIG. 2 shows a view 200 of the operation of accessing a resource via a URL according to the prior art. The browser 201 receives a URL 202 and passes a get or push command (not shown) to an operating system 204 for resolution of the domain name or URL as can be appreciated from step 202′. The operating system 204 forwards, at step 204′, the URL 202 to a domain name server 206, which looks up the received URL 202 in a database that contains one or more than one mapping between one or more than one URL and one or more than one respective IP address. In the illustrated example, there is shown a first URL 208 mapped to a respective IP address 210. The domain name server 206 returns, at step 206′, the respective IP address 210 to the operating system 204, which, at step 208′, uses it to access the server 212 to retrieve the resource 214 corresponding to the URL 202. The resource 214 corresponding to the URL 202 is returned, at step 210′ to the operating system 204 and, ultimately, to the browser 201 for rendering.

Referring to FIG. 3, there is shown a view 300 of an embodiment comprising the browser 102 having, or being capable of receiving, a URL 302 that is passed to an operating system 304, such as the above described operating system 124, for resolution at step 306. Rather than the operating system 304 passing the URL 302 to a domain name server 308 that contains an accredited registry entry 309 that maps the URL 302 or domain name 310 to a respective IP address 312, the operating system 304 is arranged to access the mapping file 116 at step 314 for resolving the domain name or URL 302. As will be appreciated the mapping file 116 contains a mapping between the URL 302 and a different, provisioned, substitute IP address 316, such as the substitute IP address 120 described above, that is different to the IP address 312 corresponding to the domain name 310 or URL held by the accredited domain name server 308.

The substitute IP address 316 is returned to the operating system at step 318. The operating system 304 uses the returned substitute IP address 316 to access, at step 320, a corresponding server 322 containing the resource 324 pointed to by the returned substitute IP address 316. The server 322 returns, at step 326, the resource 324 to the operating system 304 and, ultimately, to the browser 102, for rendering or other processing.

FIG. 4 shows a view 400 of a still further embodiment comprising a browser 402 arranged to access a given URL 404 to produce a rendered web-page 406 comprising one or more than one asset; the embodiment shown has a plurality of assets such as, for example, first and second content assets 408 and 410.

The desired URL 404 is passed to an operating system 412 to resolve the URL via an accredited DNS 414. However, instead of passing the domain name to the accredited DNS 414, the operating system 412, such as the above operating system 124, is adapted or arranged to access a mapping file 416 that contains a provisioned mapping between the URL 404 and a substitute IP address 418 that is different to the true IP address 420 corresponding to the URL 404 within the accredited DNS 414. In the illustrated example, the IP address is IP address 1 420.

The substitute IP address 418 is provisioned to point to the reverse proxy server 422/106. The reverse proxy server 422/106 also receives the URL 404. The received URL is used by the reverse proxy server 422/106 to retrieve the corresponding IP address 420 from the accredited DNS 414. The resolved IP address 420 is used by the reverse proxy server 422/106 to access the associated resource 426 via a respective server 428. The resource 426 is stored on storage 430 associated with or accessible by the server 428. It can be appreciated that the resource 426 is shown as comprising an asset 432. The accessed resource 426 is returned or sent to the reverse proxy server 422/106.

The reverse proxy server 422/106 is also, preferably, arranged to access a prescribed resource 434 via a corresponding prescribed URL 435. The prescribed resource 434 is stored on respective storage 436. It can be appreciated that the resource 434 comprises a respective asset 438.

The reverse proxy server 422/106, having accessed the resources 426 and 434, is arranged to access a resource template database 440. The resource template database 440 comprises a predetermined template 442 associated with the URL 404. The template 442 is arranged to modify or augment at least one of the presentation, the operation or the control, taken jointly and severally in any and all permutations, of at least an associated resource. It can be appreciated that the template 442 comprises at least one asset destination 444. In the embodiment shown, by way of example only, the template 442 is arranged to influence at least one of the presentation, the control or the operation, taken jointly and severally in any and all permutations, of at least one of the two assets 432 and 438 via respective asset destinations 444a and 444b, that is, the asset destination comprises a plurality of asset destinations. The plurality of asset destinations comprises a pair of destinations in the illustrated embodiment.

The reverse proxy server 422/106 populates the asset destination 444 with one or more than one appropriate or respective asset. In the illustrated embodiment, the asset destinations 444a and 444b are populated with assets 432 and 438. The populated template is then passed to the operating system 412, which, in turn, passes the populated template to the browser 402 for rendering.

It can be appreciated that the above system can be used to influence the presentation or use of data of a third party and can be used to influence at least one of the presentation, the operation or the control, taken jointly and severally in any and all permutations, of that data, which data can take the form of a web-page such as, for example, one or more than one third party web-page. The third party data or third party web-page can be retrieved and modified or augmented in some way before it is presented to the browser 402.

The above modifying or augmenting takes place transparently from the perspective of the browser 402 and redirection exceptions do not arise because, again, from the perspective of the browser 402, the original IP address, or security context, of the request for information issued by the browser is preserved. The browser is unaware that the original request, containing the original IP address, has been directed to the reverse proxy server's IP address via a substitute IP address by the operating system accessing the mapping file 416 that provides the substitute IP address 418. The operating system ensures that the security context is preserved when providing the response to the original request to the browser. For example, supposing the browsers described herein used a Same Origin policy, the responding protocol, host, port permutation would have to match the originating protocol, host, port permutation of the original request. This security context is preserved because using a substitute IP address is transparent to the browser.

The modification and/or augmentation described herein with reference to any and all embodiments can take many forms such as, for example, adding content, such as, for example, additional graphical material, to an existing web-page or third party data, adding processing functionality, in the form of code or scripts, to the third party web-page or third party data, reformatting the presentation of third party data or a third party web-page, the reformatting can relate to the spatial distribution of content and/or the timing of presenting any such content, that is, the temporal distribution of content, all taken jointly and severally in any and all permutations. For example, a third party web-page can be modified to include a button together with associated code such that actuating the button on the rendered web-page invokes an operation; the operation being associated with the associated code or invoked by the associated code.

Although the resources 426 and 434 above are described and shown as comprising two assets 432 and 438 embodiments are not limited thereto. The resources 426 and 438 can equally well comprise at least one or more of data, controls, code, scripts, a complete document such as an xml, html document or the like and any other asset taken jointly and severally in any and all permutations.

Embodiments can be realised in which retrieved content, as well as being augmented, or instead of being augmented, can be rearranged before being rendered or processed by the browser, which advantageously allows the format of third party data, such as, for example, a web-page, to be rearranged to suit a user's needs.

Therefore, referring to FIG. 5, there is shown a view 500 of a still further embodiment comprising a browser 502 arranged to access a given URL 504 to produce a rendered web-page 506 comprising first and second content assets 508 and 510. The first and second content assets 508 and 510 have a predetermined spatial and/or temporal disposition relative to one another. In the illustrated embodiment, the first and second content assets 508 and 510 are horizontally disposed relative to one another, but could equally well have some other spatial and/or temporal relative disposition. The desired URL 504 is passed to an operating system 512 to resolve the URL via an accredited DNS 514. However, instead of resolving the URL 504 via the accredited DNS 514, the operating system 512 accesses a mapping file 516 that contains a provisioned mapping between the URL 504 and a substitute IP address 518 that is different to the IP address 520 corresponding to the URL 504 within the accredited DNS 514.

The substitute IP address 518 is provisioned to point to a reverse proxy server 522/106. The reverse proxy server 522/106 also receives the URL 504. The received URL 504 is used by the reverse proxy server 522/106 to retrieve the corresponding IP address 520 from the accredited DNS 514. The resolved IP address 520 is used by the reverse proxy server 522/106 to access an associated resource 526 via a respective server 528. The resource 526 is stored on storage 530 associated with or accessible by the server 528. It can be appreciated that the resource 526 is shown as comprising a plurality of assets; namely, two assets 532 and 538 in the present example. The accessed resource 526 is returned or sent to the reverse proxy server 522/106. The plurality of assets can be arranged to have a predetermined spatial and/or temporal disposition when processed by the browser 502.

The reverse proxy server 522/106, having accessed the resource 526, is arranged to access a resource template database 540 that contains a predetermined template 542 associated with the URL 504. The template 542 is arranged to modify or augment at least one of the presentation, the operation or the control, taken jointly and severally in any and all permutations, of at least one of an associated resource. It can be appreciated that the template 542 comprises at least one asset destination 544. In the embodiment shown, by way of example only, the template 542 is arranged to influence at least one of the presentation, the control or the operation, taken jointly and severally in any and all permutations, of one or more of a plurality of assets, such as the two assets 532 and 538, via respective asset destinations 544a and 544b, that is, the asset destination 544 comprises a plurality of asset destinations.

The reverse proxy server 522/106 populates the asset destination 544 with one or more than one appropriate or respective asset. In the illustrated embodiment, the asset destinations 544a and 544b are populated with assets 532 and 538. The populated template is then passed to the operating system 512, via the reverse proxy server 522/106, which, in turn, passes the populated template to the browser 506 for rendering. It can be appreciated that the rendered web-page 506 has the two assets 508 and 510 derived from assets 532 and 538 arranged differently, in this example horizontally, relative to one another as compared to their disposition relative to one another in the original web-page or resource 526.

It can be appreciated that the above system can be used to influence at least one of the presentation and the use of data of a third party and, in particular, third party web-pages. The third party web-page can be retrieved and modified in some way before it is presented to the browser 502. The above modifying or augmenting takes place transparently from the perspective of the browser 502 and redirection exceptions do not arise because, again, from the perspective of the browser 502, the original IP address, or security context, of the request for information issued by the browser is preserved. The browser is unaware that the original request, containing the original IP address, has been directed to the reverse proxy server's IP address via a substitute IP address by the operating system accessing the mapping file 516 that provides the substitute IP address 518. The operating system ensures that the security context is preserved when providing the response to the original request to the browser. For example, supposing the browsers described herein used a Same Origin policy, the responding protocol, host, port permutation would have to match the originating protocol, host, port permutation of the original request. This security context is preserved because using a substitute IP address is transparent to the browser 502.

In the above embodiments, the modifications and/or augmentations comprise rearranging the assets of a web-page, in effect, changing its layout, or supplementing its content. However, embodiments are not limited thereto. The modifications and/or augmentations can take many forms such as, for example, at least one or more of the following, taken jointly and severally in any and all combinations: adding additional content, reducing the third party content, rearranging the content, processing the content, modifying controls associated with content or a resource, adding controls to be associated with content or to a resource, adding controls to be associated with content or to a resource.

The resource 526 above is described and shown as comprising assets 532 and 538. The resource 526, or one or more than one of the assets 532 and 538, can comprise at least one or more of data, controls, code, scripts, a complete document such as an xml, html document or the like and any other asset taken jointly or severally in any and all permutations.

Embodiments can be realised in which a retrieved resource has associated controls. The controls influence the operation of the resource or invoke one or more than one operation associated with the resource. Therefore, referring to FIG. 6, there is shown a view 600 of a still further embodiment comprising a browser 602 arranged to access a given URL 604 to produce a rendered web-page 606 comprising a first associated control 608. The first associated control 608 is arranged to influence the operation of the web-page 606. The desired URL 604 is passed to an operating system 612 to resolve the URL via an accredited DNS 614. However, instead of resolving the URL 604 via the accredited DNS 614, the operating system 612 accesses a mapping file 616 that contains a provisioned mapping between the URL 604 and a substitute IP address 618 that is different to the IP address 620 corresponding to the URL 604 within the accredited DNS 614.

The substitute IP address 618 is provisioned to point to a reverse proxy server 622/106. The reverse proxy server 622/106 receives the URL 604 from the OS 612. The received URL 604 is used by the reverse proxy server 622/106 to retrieve the corresponding IP address 620 from the accredited DNS 614. The resolved IP address 620 is used by the reverse proxy server 622/106 to access an associated resource 626 via a respective server 628. The resource 626 is stored on storage 630 associated with or accessible by the server 628. It can be appreciated that the resource 626 is shown as comprising a respective control 632. The accessed resource 626 is returned or sent to the reverse proxy server 622/106.

The reverse proxy server 622/106, having accessed the resource 626, is arranged to access a resource template database 640 that contains a predetermined template 642 associated with the URL 604. The template 642 is arranged to process the control 632 to produce an alternative control 644a. The alternative control 644a can supplement the original control 632 by adding one or more than one further control, modify the original control 632 by entirely replacing the original control 632 with an alternative control or by replacing the original control 632 in part, or by deleting the original control at least in part or entirely or by supplementing the original control 632 at least in part.

The reverse proxy server 622/106 populates the template 642 with the alternative control 644a. The populated template 642 is then passed to the operating system 612, via the reverse proxy server 622/106, which, in turn, passes the populated template 642 to the browser 602 for rendering. It can be appreciated that the browser 602 gives effect to the alternative controls 644a when rendering the web-page 606.

It can be appreciated that the above system can be used to influence the operation, presentation or use of data of a third party. Embodiments of such data can be, for example, one or more than one third party web-page. The third party data or web-page can be retrieved and modified in some way before it is presented to the browser 602. The above modifying or augmenting takes place transparently from the perspective of the browser 602 and redirection exceptions do not arise because, again, from the perspective of the browser 602, the original IP address, or security context, of the request for information issued by the browser is preserved. The browser is unaware that the original request, containing the original IP address, has been directed to the reverse proxy server's IP address via the substitute IP address by the operating system accessing the mapping file 416 that provides the substitute IP address 618. The operating system ensures that the security context is preserved when providing the response to the original request to the browser. For example, supposing the browsers described herein use a Same Origin policy, the responding protocol, host, port permutation would have to match the originating protocol, host, port permutation of the original request. This security context is preserved because using a substitute IP address is transparent to the browser.

For example, data such as third party data may have a particular associated functionality. Embodiments can be realised in which that associated functionality is completely replaced by a different functionality or is augmented by additional functionality or is modified by additional functionality. Additionally, or alternatively, that existing functional can be deleted or amended. For example, a web-page may comprise a payment button that invokes functionality associated with making a payment by presenting and acting upon a generic payment form, followed by a further web-page confirming payment. Invoking the payment button to produce that associated generic payment functionality can be changed such that a different web-page is presented containing, for example, prescribed and/or pre-populated payment options together with associated scripts instead of the generic payment form. Control can be returned to the further web-page confirming payment once the alternative functionality has completed.

Referring to FIG. 7, there is shown a view 700 of a HOSTS file, which is an embodiment of a mapping file 416, 516, 616 described above. It can be appreciated that the HOSTS file, which can be used to implement any of the above mapping files, comprises one or more than one provisioned mapping between a first type of representation of a URI or URL, such as a text representation, and a corresponding substitute IP address. The HOSTS file is an embodiment of a database adapted to map a resource identifier, such as, for example, a URL or IP address, to a substitute resource identifier, such as, a URL or IP address. The substitute IP address is not the IP address that an accredited DNS would associate with the URI or URL. The substitute IP address is associated with one or more than one reverse proxy server such as one or more than one of the above-described reverse proxy servers. In the embodiment illustrated in FIG. 7, the HOSTS file 700 contains a substitute IP address 702 that is used to resolve an access to the corresponding web-site www.google.com 704 notwithstanding that web-site having, from the perspective of an accredited DNS or other entity, a different IP address. In general the HOSTS file 704 will be provisioned to map a first representation of a URL or URI 706 to a corresponding substitute IP address 708 where the substitute IP address 708 is not the IP address ordinarily associated, by an accredited DNS or the like, with that URL or URI 706. The substitute IP address 708 is arranged to direct any request for resources associated with the URL or URI of interest 706 to a reverse proxy server.

Referring to FIG. 8, there is shown a flowchart 800 of processing according to an embodiment. A suitable programmed or otherwise configured processor can be arranged to implement one or more of the features of the flowchart 800.

The resource identifier, such as, for example, a URL of a web-page of interest is received or otherwise determined at 802. The resource identifier can be input to a browser by a user of that browser or can be otherwise provided as part of a program instruction, script instruction or command. The resource identifier is sent to the operating system where it is mapped to a substitute resource identifier via, for example, the HOSTS file or other operating system database at 804.

The operating system routes the first resource identifier to the substitute resource identifier. The substitute resource identifier is associated with a content enrichment server, that is, reverse proxy server as described herein, where the content enrichment server retrieves a first resource, such as, for example, a web-page or other web or URL accessible at 806.

At 808 the content enrichment server modifiers the first resource and the modified first resource is output, at 810, for processing by the browser via the operating system.

FIG. 9 depicts a further flowchart 900 according to an embodiment. The flowchart 900. At 902, the browser receives a resource identifier, such as a URL for example, associated with a resource such as a web-page of interest. The browser forwards the resource identifier to the operating system at 904. Rather than the operating system merely giving effect to the instruction from the browser to retrieve the resource associated with the resource identifier, the operating system accesses, at 906, an operating system database such as, for example, the HOSTS file. The database is provisioned in advance of the access to contain a mapping between the resource identifier and a substitute resource identifier. The substitute resource identifier is returned to the operating system at 908. The substitute resource identifier is arranged to direct the operating system to a content enrichment server at 910 together with the resource identifier. At 912, the content enrichment server requests a respective resource associated with the resource identifier and receives that resource at 914 from a server or other system hosting the resource associated with the resource identifier.

The content enrichment server accesses a database containing data or other content to be used to modify respective resource at 916 and receives that data at 918. Having received the data or other content for modifying the resource associated with the resource identifier, the content enrichment server modifies the retrieved resource according to the retrieved data or other content at 920 and forwards the resulting modified resource to the operating system. In turn, the operating system forwards the modified resource to the browser at 922. The browser processes the modified resource at 924, which can comprise, for example, rendering the modified resource to a user.

FIG. 10 shows schematically a data processing system 1000 for implementing one or more than one aspect of any of the embodiments such as, for example, the web-browser, the content enrichment server and/or associated databases. It can be appreciated that processes or methods described herein can be realised in the form of executable instructions that can be executed by the data processing system 1000.

The data processing system 1000 comprising one or more processor(s) 1040, system control logic 1020 coupled with at least one of the processor(s) 1040, system memory 1010 coupled with system control logic 1020, non-volatile memory (NVM)/storage 1030 coupled with system control logic 1020, and a network interface 1060 coupled with system control logic 1020. The system control logic 1020 may also be coupled to Input/Output devices 1050.

Processor(s) 1040 may include one or more single-core or multi-core processors. Processor(s) 1040 may include any combination of general-purpose processors and dedicated processors (e.g., graphics processors, application processors, etc.). Processors 1040 may be operable to carry out the above described methods, using suitable instructions or programs (i.e. operate via use of processor, or other logic, instructions). The instructions may be stored in system memory 1010 or additionally or alternatively may be stored in (NVM)/storage 1030 to thereby instruct the one or more processors 1040 to carry method set-out herein.

System control logic 1020 for one embodiment may include any suitable interface controllers to provide for any suitable interface to at least one of the processor(s) 1040 and/or to any suitable device or component in communication with system control logic 1020.

System control logic 1020 for one embodiment may include one or more memory controller(s) (not shown) to provide an interface to system memory 1010. System memory 1010 may be used to load and store data and/or instructions, for example, for system 1000. System memory 1010 for one embodiment may include any suitable volatile memory, such as suitable dynamic random access memory (DRAM), for example.

NVM/storage 1030 may include one or more tangible, non-transitory computer-readable media used to store data and/or instructions, for example. NVM/storage 1030 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 1030 may include a storage resource physically part of a device on which the system 1000 is installed or it may be accessible by, but not necessarily a part of, the device. For example, the NVM/storage 1030 may be accessed over a network via the network interface 1060.

System memory 1010 and NVM/storage 1030 may respectively include, in particular, temporal and persistent copies of, for example, the instructions memory portions retrieving and augmenting a web-page or other resource.

Network interface 1060 may provide a radio interface for system 1000 to communicate over one or more network(s) (e.g. wireless communication network) and/or with any other suitable device.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide machine executable code for implementing a system, device or method as described herein or as claimed herein and machine readable storage storing such a program. Still further, such programs may be conveyed electronically via any medium such as a communication signal carried over a wired or wireless connection and embodiments suitably encompass the same. Any such machine executable instructions can be executed by one or more than one respective processor. Suitably, such processors are configured to implement embodiments described and claimed herein.

Embodiments can be realised according to the following clauses:

Clause 1. A data processing system, comprising

a, preferably operating system, database, such as, for example, a HOSTS file, adapted to map a first resource identifier, such as, for example, at least a hostname or a URL, to a substitute resource identifier; the substitute resource identifier such as, for example, at least a hostname or a URL, being associated with a proxy server; the first resource identifier being within a respective security context of a browser adapted for accessing a first resource, via the first resource identifier, the first resource being accessible by a first respective server; the (preferably operating system) database being external to the respective security context of the browser, and

optionally, the proxy server being adapted to retrieve the first resource via the first resource identifier and to at least modify the retrieved first resource, the proxy server being further adapted to output the modified first resource for processing by the browser preserving the security context of the first browser.

Clause 2. A data processing system of clause 1, wherein the first resource identifier comprises a hostname or is a URL.

Clause 3. A data processing system of clause 2, wherein at least one of the first resource identifier, hostname and URL is associated with a first IP address.

Clause 4. A data processing of any preceding clause wherein the substitute resource identifier comprises a hostname or is a URL.

Clause 5. A data processing system of clause 4, wherein at least one of the substitute resource identifier, hostname and URL is associated with a substitute IP address.

Clause 6. A data processing system of any preceding clause, wherein the proxy server being adapted to retrieve the first resource, optionally via the first associated IP address, and to modify the retrieved first resource comprises at least a processor configured

a. to, or comprising means to, modify content of or content associated with the retrieved first resource, said modifying comprises at least partially deleting said content.

Clause 7. A data processing system of any preceding clause, wherein the proxy server being adapted to retrieve the first resource via the first associated IP address and to modify the retrieved first resource comprises at least a processor configured

a. to, or comprising means to, modify content of or content associated with the retrieved first resource, said modifying comprises supplementing said content with additional content.

Clause 8. A data processing system of any preceding clause, wherein the proxy server being adapted to retrieve the first resource via the first associated IP address and to modify the retrieved first resource comprises at least a processor configured

a. to, or comprising means adapted to, modify content of or content associated with the retrieved first resource, said modifying comprises replacing at least partially said content or at least part of said retrieved content with replacement content.

Clause 9. A data processing system of any preceding clause, wherein the proxy server being adapted to retrieve the first resource via the first associated IP address and to modify the retrieved first resource comprises at least a processor configured

a. to, or means adapted to, modify content of or content associated with the retrieved first resource, said modifying comprises reformatting the spatial distribution of the content of or associated with the retrieved first resource.

Clause 10. A data processing system of any preceding clause, wherein the proxy server being adapted to retrieve the first resource via the first associated IP address and to modify the retrieved first resource comprises at least a processor configured

a. to, or means adapted to, modify content of or content associated with the retrieved first resource, said modifying comprises reformatting the temporal presentation of the content of or associated with the retrieved first resource.

Clause 11. A data processing system of any preceding clause, wherein the proxy server being adapted to retrieve the first resource via the first associated IP address and to modify the retrieved first resource comprises at least a processor configured

a. to, or comprising means adapted to, substitute at least part, or the whole, of a retrieved resource with a replacement resource.

Clause 12. A data processing system of any preceding clause, further comprising a processor configured to, or comprising means to, perform one or more than one operation associated with a retrieved resource.

Clause 13. A data processing system of clause 12, wherein the processor configured to, or comprising means to, perform one or more than one operation associated with a retrieved resource is configured to, or comprises means to, process one or more than one retrieved instruction associated with the retrieved resource.

Clause 14. A data processing system of either of clauses 12 and 13, wherein the processor configured to, or comprising means to, perform one or more than one operation associated with a retrieved resource is configured to, or comprises means to, influence execution of one or more than one retrieved instruction associated with the retrieved resource.

Clause 15. A data processing system of clause 14, wherein the processor configured to, or comprising means to, influence execution of one or more than one retrieved instruction associated with the retrieved resource is configured to, or comprises means to:

a. delete the one or more than one instruction;

b. prevent execution of the one or more than one instruction;

c. replace the one or more than one instruction with an alternative instruction;

d. supplement the one or more than one instruction with at least one additional instruction

taken jointly and severally in any and all combinations.

Clause 16. A data processing system of any preceding clause, wherein the content of or content associated with the retrieved first resource comprises at least one or more of

a. data of or associated with a web-page, and

b. code of or associated with a web-page.

Clause 17. A data processing method, comprising

a. accessing a database, such as, for example, an operating system database, such as, for example, a HOSTS file, adapted to map a first resource identifier, such as, for example, at least a hostname or a URL, to a substitute resource identifier, such as, for example, a hostname or a URL; the substitute resource identifier being associated with a proxy server; the first resource identifier being within a respective security context of a browser adapted for accessing a first resource, via the first resource identifier, the first resource being accessible by a first respective server; the database being external to the respective security context of the browser, and

b. retrieving the first resource via the proxy server being adapted to retrieve the first resource via the first resource identifier and at least modifying the retrieved first resource, outputting, via the proxy server, the modified first resource for processing by the browser preserving the security context of the first browser.

Clause 18. A method clause 17, wherein the first resource identifier comprises a hostname or is a URL.

Clause 19. A method of clause 18, wherein at least one of the first resource identifier, hostname and URL is associated with a first IP address.

Clause 20. A method of any of clauses 17 to 19, wherein the substitute resource identifier comprises at least a hostname or is a URL.

Clause 21. A method of clause 20, wherein at least one of the substitute resource identifier, hostname and URL is associated with a substitute IP address.

Clause 22. A method of any of clauses 17 to 21, wherein the modifying by the proxy server comprises at least

a. modifying content of or content associated with the retrieved first resource, said modifying comprising at least partially deleting said content.

Clause 23. A method of any of clauses 17 to 22, wherein the modifying by the proxy server comprises at least

a. modifying content of or content associated with the retrieved first resource, said modifying comprising supplementing said content with additional content.

Clause 24. A method of any of clauses 17 to 23, wherein the modifying by the proxy server comprises at least

a. modifying content of or content associated with the retrieved first resource, said modifying comprising replacing at least partially said content with replacement content.

Clause 25. A method of any of clauses 17 to 24, wherein the modifying by the proxy server comprises at least

a. modifying content of or content associated with the retrieved first resource, said modifying comprising reformatting the spatial distribution of the content of or content associated with the retrieved first resource.

Clause 26. A method of any of clauses 17 to 25, wherein the modifying by the proxy server comprises at least

a. modifying content of or content associated with the retrieved first resource, said modifying comprising reformatting the temporal presentation of the content of or content associated with the retrieved first resource.

Clause 27. A method of any of clauses 17 to 26, wherein the modifying by the proxy server comprises at least

a. substituting at least part, or the whole, of a retrieved resource with replacement resource.

Clause 28. A method of any of clauses 17 to 27, further comprising performing one or more than one operation associated with a retrieved resource.

Clause 29. A method of clause 28, wherein the performing the one or more than one operation associated with a retrieved resource comprises processing one or more than one retrieved instruction associated with the retrieved resource.

Clause 30. A method of either of clauses 28 and 29, wherein performing the one or more than one operation associated with a retrieved resource comprises influencing execution of one or more than one retrieved instruction associated with the retrieved resource.

Clause 31. A method of clause 30, wherein influencing the execution of one or more than one retrieved instruction associated with the retrieved resource comprises one or more of the following taken jointly and severally in any and all combinations:

a. deleting the one or more than one instruction;

b. preventing execution of the one or more than one instruction;

c. replacing the one or more than one instruction with at least one alternative instruction;

d. supplementing the one or more than one instruction with at least one additional instructions.

Clause 32. A method of any of clauses 17 to 31, wherein the content of or content associated with the retrieved first resource comprises at least one or more of

a. data of or data associated with a web-page, and

b. code of or data associated with a web-page.

Clause 33. Machine-executable program comprising instructions arranged, when executed, to implement a method or realise a system of any preceding clause.

Clause 34. Machine readable storage storing a machine-executable program of clause 33.

Clause 35. A data processing system, comprising

a. a database adapted to map a first associated IP address to a substitute IP address; the substitute IP address being associated with a proxy server; the first associated IP address being within a respective security context of a browser adapted for accessing a first resource, via the first associated IP address, the first resource being accessible by a first respective server; the database being external to the respective security context of the browser, and

b. the proxy server being adapted to retrieve the first resource via the first associated IP address and to at least modify the retrieved first resource, the proxy server being further adapted to output the modified first resource for processing by the browser preserving the security context of the first browser.

Clause 36. A data processing system of clause 35, wherein the proxy server being adapted to retrieve the first resource via the first associated IP address and to modify the retrieved first resource comprises at least

a. means adapted to modify content of or content associated with the retrieved first resource, said modifying comprises at least partially deleting said content.

Clause 37. A data processing system of any of clauses 35 to 36, wherein the proxy server being adapted to retrieve the first resource via the first associated IP address and to modify the retrieved first resource comprises at least

a. means adapted to modify content of or content associated with the retrieved first resource, said modifying comprises supplementing said content with additional content.

Clause 38. A data processing system of any of clauses 35 to 37, wherein the proxy server being adapted to retrieve the first resource via the first associated IP address and to modify the retrieved first resource comprises at least

a. means adapted to modify content of or content associated with the retrieved first resource, said modifying comprises replacing at least partially said content or at least part of said retrieved content with replacement content.

Clause 39. A data processing system of any of clauses 35 to 38, wherein the proxy server being adapted to retrieve the first resource via the first associated IP address and to modify the retrieved first resource comprises at least

a. means adapted to modify content of or content associated with the retrieved first resource, said modifying comprises reformatting the spatial distribution of the content of or associated with the retrieved first resource.

Clause 40. A data processing system of any of clauses 35 to 39, wherein the proxy server being adapted to retrieve the first resource via the first associated IP address and to modify the retrieved first resource comprises at least

a. means adapted to modify content of or content associated with the retrieved first resource, said modifying comprises reformatting the temporal presentation of the content of or associated with the retrieved first resource.

Clause 41. A data processing system of any of clauses 35 to 40, wherein the proxy server being adapted to retrieve the first resource via the first associated IP address and to modify the retrieved first resource comprises at least

a. means adapted to substitute at least part, or the whole, of a retrieved resource with a replacement resource.

Clause 42. A data processing system of any of clauses 35 to 41, further comprising means to perform one or more than one operation associated with a retrieved resource.

Clause 43. A data processing system of clause 42, wherein the means to perform one or more than one operation associated with a retrieved resource comprises means to process one or more than one retrieved instruction associated with the retrieved resource.

Clause 44. A data processing system of either of clauses 42 and 43, wherein the means to perform one or more than one operation associated with a retrieved resource comprises means to influence execution of one or more than one retrieved instruction associated with the retrieved resource.

Clause 45. A data processing system of clause 44, wherein the means to influence execution of one or more than one retrieved instruction associated with the retrieved resource comprises one or more of the following taken jointly and severally in any and all combinations:

a. deleting the one or more than one instruction;

b. preventing execution of the one or more than one instruction;

c. replacing the one or more than one instruction with an alternative instruction;

d. supplementing the one or more than one instruction with at least one additional instruction.

Clause 46. A data processing system of any of clauses 35 to 45, wherein the content of or content associated with the retrieved first resource comprises at least one or more of

a. data of or associated with a web-page, and

b. code of or associated with a web-page.

Clause 47. Machine executable instructions arranged, when executed by one or more than one processor, to configure the one or more than one processor for

a. accessing a database adapted to map a first associated IP address to a substitute IP address; the substitute IP address being associated with a proxy server; the first associated IP address being within a respective security context of a browser adapted for accessing a first resource, via the first associated IP address, the first resource being accessible by a first respective server; the database being external to the respective security context of the browser, and

b. retrieving the first resource via the proxy server being adapted to retrieve the first resource via the first associated IP address and at least modifying the retrieved first resource, outputting, via the proxy server, the modified first resource for processing by the browser preserving the security context of the first browser.

Clause 48. The machine executable instructions of clause 47, wherein the modifying by the proxy server comprises at least

a. modifying content of or content associated with the retrieved first resource, said modifying comprising at least partially deleting said content.

Clause 49. The machine executable instructions of either of clauses 47 and 48, wherein the modifying by the proxy server comprises at least

a. modifying content of or content associated with the retrieved first resource, said modifying comprising supplementing said content with additional content.

Clause 50. The machine executable instructions of clauses 47 to 49, wherein the modifying by the proxy server comprises at least

a. modifying content of or content associated with the retrieved first resource, said modifying comprising replacing at least partially said content with replacement content.

Clause 51. The machine executable instructions of clause 47 to 50, wherein the modifying by the proxy server comprises at least

a. modifying content of or content associated with the retrieved first resource, said modifying comprising reformatting the spatial distribution of the content of or content associated with the retrieved first resource.

Clause 52. The machine executable instructions of clauses 47 to 51, wherein the modifying by the proxy server comprises at least

a. modifying content of or content associated with the retrieved first resource, said modifying comprising reformatting the temporal presentation of the content of or content associated with the retrieved first resource.

Clause 53. The machine executable instructions of clauses 47 to 52, wherein the modifying by the proxy server comprises at least

a. substituting at least part, or the whole, of a retrieved resource with replacement resource.

Clause 54. The machine executable instructions of clauses 47 to 53, further comprising performing one or more than one operation associated with a retrieved resource.

Clause 55. The machine executable instructions of clause 54, wherein the performing the one or more than one operation associated with a retrieved resource comprises processing one or more than one retrieved instruction associated with the retrieved resource.

Clause 56. The machine executable instructions of clauses 54 and 55, wherein performing the one or more than one operation associated with a retrieved resource comprises influencing execution of one or more than one retrieved instruction associated with the retrieved resource.

Clause 57. The machine executable instructions of clause 56, wherein influencing the execution of one or more than one retrieved instruction associated with the retrieved resource comprises one or more of the following taken jointly and severally in any and all combinations:

a. deleting the one or more than one instruction;

b. preventing execution of the one or more than one instruction;

c. replacing the one or more than one instruction with at least one alternative instruction;

d. supplementing the one or more than one instruction with at least one additional instructions.

Clause 58. The machine executable instructions of clauses 47 to 57, wherein the content of or content associated with the retrieved first resource comprises at least one or more of

a. data of or data associated with a web-page, and

b. code of or data associated with a web-page.

Clause 59. Non-transitory machine readable storage storing machine executable instructions of any preceding method.

Clause 60. A data processing system substantially as described herein with reference to and/or illustrated in one or more of the accompanying drawings.

Clause 61. A method substantially as described herein with reference to and/or illustrated in one or more of the accompanying drawings.

Clause 62. Machine executable program substantially as described herein with reference to and/or illustrated in one or more of the accompanying drawings.

Clause 63. Machine readable storage substantially as described herein with reference to and/or illustrated in one or more of the accompanying drawings.

One skilled in the art will appreciate that the machine hosting or otherwise running the browser will need provisioning, or otherwise provided, with access to the operating system database such as, for example, the HOSTS file. Similarly, suitable software will need to be provided for the proxy server to allow that server to retrieve an identified resource, to modify and forward the modified version of the identifier resource for processing by the browser. Therefore, embodiments provide method, systems and computer programs according to the following clauses:

Clause 64. A method of configuring a machine for content adaptation, the method comprising

providing a, preferably operating system, database, such as, for example, a HOSTS file, adapted to map a first resource identifier, such as, for example, at least a hostname or a URL, to a substitute resource identifier; the substitute resource identifier such as, for example, at least a hostname or a URL, being associated with a proxy server; the first resource identifier being within a respective security context of a browser adapted for accessing a first resource, via the first resource identifier, the first resource being accessible by a first respective server; the (preferably operating system) database being external to the respective security context of the browser, and

configuring the proxy server to retrieve the first resource via the first resource identifier and to at least modify the retrieved first resource, the proxy server being further configured to output the modified first resource for processing by the browser preserving the security context of the first browser.

Clause 65. The method of clause 64, wherein the first resource identifier comprises a hostname or is a URL.

Clause 66. The method of clause 65, wherein at least one of the first resource identifier, hostname and URL is associated with a first IP address.

Clause 67. The method of any preceding clause wherein the substitute resource identifier comprises a hostname or is a URL.

Clause 68. The method of clause 67, wherein at least one of the substitute resource identifier, hostname and URL is associated with a substitute IP address.

Clause 69. The method of any preceding clause, wherein the proxy server being adapted to retrieve the first resource, optionally via the first associated IP address, and to modify the retrieved first resource comprises at least a processor configured

a. to, or comprising means to, modify content of or content associated with the retrieved first resource, said modifying comprises at least partially deleting said content.

Clause 70. The method of any preceding clause, wherein the proxy server being adapted to retrieve the first resource via the first associated IP address and to modify the retrieved first resource comprises at least a processor configured

a. to, or comprising means to, modify content of or content associated with the retrieved first resource, said modifying comprises supplementing said content with additional content.

Clause 71. The method of any preceding clause, wherein the proxy server being adapted to retrieve the first resource via the first associated IP address and to modify the retrieved first resource comprises at least a processor configured

a. to, or comprising means adapted to, modify content of or content associated with the retrieved first resource, said modifying comprises replacing at least partially said content or at least part of said retrieved content with replacement content.

Clause 72. The method of any preceding clause, wherein the proxy server being adapted to retrieve the first resource via the first associated IP address and to modify the retrieved first resource comprises at least a processor configured

a. to, or means adapted to, modify content of or content associated with the retrieved first resource, said modifying comprises reformatting the spatial distribution of the content of or associated with the retrieved first resource.

Clause 73. The method of any preceding clause, wherein the proxy server being adapted to retrieve the first resource via the first associated IP address and to modify the retrieved first resource comprises at least a processor configured

a. to, or means adapted to, modify content of or content associated with the retrieved first resource, said modifying comprises reformatting the temporal presentation of the content of or associated with the retrieved first resource.

Clause 74. The method of any preceding clause, wherein the proxy server being adapted to retrieve the first resource via the first associated IP address and to modify the retrieved first resource comprises at least a processor configured

a. to, or comprising means adapted to, substitute at least part, or the whole, of a retrieved resource with a replacement resource.

Clause 75. The method of any preceding clause, further comprising a processor configured to, or comprising means to, perform one or more than one operation associated with a retrieved resource.

Clause 76. The method of clause 75, wherein the processor configured to, or comprising means to, perform one or more than one operation associated with a retrieved resource is configured to, or comprises means to, process one or more than one retrieved instruction associated with the retrieved resource.

Clause 77. The method of either of clauses 12 and 13, wherein the processor configured to, or comprising means to, perform one or more than one operation associated with a retrieved resource is configured to, or comprises means to, influence execution of one or more than one retrieved instruction associated with the retrieved resource.

Clause 78. The method of clause 77, wherein the processor configured to, or comprising means to, influence execution of one or more than one retrieved instruction associated with the retrieved resource is configured to, or comprises means to:

a. delete the one or more than one instruction;

b. prevent execution of the one or more than one instruction;

c. replace the one or more than one instruction with an alternative instruction;

d. supplement the one or more than one instruction with at least one additional instruction

taken jointly and severally in any and all combinations.

Clause 79. The method of any preceding clause, wherein the content of or content associated with the retrieved first resource comprises at least one or more of

a. data of or associated with a web-page, and

b. code of or associated with a web-page.

Embodiments can be realised in which the machine hosting the browser and the machine hosting or otherwise performing the function of the proxy server are separate machine or one and the same machine. Suitably, embodiments provide a data processing system, method or machine readable storage retrieving the first resource via a proxy server is performed by the machine hosting the data or is performed by an entirely separate machine. Therefore, embodiments provide proxy server comprises a processor configured for retrieving the first resource via the proxy server being adapted to retrieve the first resource via the first resource identifier and at least modifying the retrieved first resource, outputting, via the proxy server, the modified first resource for processing by the browser preserving the security context of the first browser. Further embodiments comprise a proxy server having at least one processor for implementing a method according to any method clause described herein.

1. Non-transitory machine readable storage storing instructions arranged, when executed by at least one processor, to configure a machine for:
a. accessing an operating system database adapted to map a first resource identifier to a substitute resource identifier; the substitute resource identifier being associated with a proxy server; the first resource identifier being within a respective security context of a browser adapted for accessing a first resource, via the first resource identifier, the first resource being accessible by a first respective server; the operating system database being external to the respective security context of the browser, and
b. retrieving the first resource via the proxy server being adapted to retrieve the first resource via the first resource identifier and at least modifying the retrieved first resource, outputting, via the proxy server, the modified first resource for processing by the browser preserving the security context of the first browser.

2. The non-transitory machine readable storage of claim 1, wherein the modifying by the proxy server comprises at least modifying content of or content associated with the retrieved first resource, said modifying comprising at least partially deleting said content.

3. The non-transitory machine readable storage of claim 1, wherein the modifying by the proxy server comprises at least modifying content of or content associated with the retrieved first resource, said modifying comprising supplementing said content with additional content.

4. The non-transitory machine readable storage of claim 1, wherein the modifying by the proxy server comprises at least modifying content of or content associated with the retrieved first resource, said modifying comprising replacing at least partially said content with replacement content.

5. The non-transitory machine readable storage of claim 1, wherein the modifying by the proxy server comprises at least modifying content of or content associated with the retrieved first resource, said modifying comprising reformatting the spatial distribution of the content of or content associated with the retrieved first resource.

6. The non-transitory machine readable storage of claim 1, wherein the modifying by the proxy server comprises at least modifying content of or content associated with the retrieved first resource, said modifying comprising reformatting the temporal presentation of the content of or content associated with the retrieved first resource.

7. The non-transitory machine readable storage of claim 1, wherein the modifying by the proxy server comprises at least substituting at least part, or the whole, of a retrieved resource with replacement resource.

8. The non-transitory machine readable storage of claim 1, further comprising performing one or more than one operation associated with a retrieved resource.

9. The non-transitory machine readable storage of claim 8, wherein the performing the one or more than one operation associated with a retrieved resource comprises processing one or more than one retrieved instruction associated with the retrieved resource.

10. The non-transitory machine readable storage of claim 8, wherein performing the one or more than one operation associated with a retrieved resource comprises influencing execution of one or more than one retrieved instruction associated with the retrieved resource.

11. The non-transitory machine readable storage of claim 10, wherein influencing the execution of one or more than one retrieved instruction associated with the retrieved resource comprises one or more of the following:
a. deleting the one or more than one instruction;
b. preventing execution of the one or more than one instruction;
c. replacing the one or more than one instruction with at least one alternative instruction; or
d. supplementing the one or more than one instruction with at least one additional instructions.

12. The non-transitory machine readable storage of claim 1, wherein the content of or content associated with the retrieved first resource comprises at least one or more of
a. data of or data associated with a web-page, and
b. code of or data associated with a web-page.

13. A data processing system, comprising
an operating system file adapted to map a first resource identifier to a substitute resource identifier; the substitute resource identifier being associated with a proxy server; the first resource identifier being within a respective security context of a browser adapted for accessing a first resource, via the first resource identifier, the first resource being accessible by a first respective server; the file being external to the respective security context of the browser, and
the proxy server being adapted to retrieve the first resource via the first resource identifier and to at least modify the retrieved first resource, the proxy server being further adapted to output the modified first resource for processing by the browser preserving the security context of the first browser.

14. The data processing system of claim 13, wherein the proxy server being adapted to retrieve the first resource and to modify the retrieved first resource comprises at least a processor configured to modify content of or content associated with the retrieved first resource, said modifying comprises at least partially deleting said content.

15. The data processing system of claim 13, wherein the proxy server being adapted to retrieve the first resource via the first associated IP address and to modify the retrieved first resource comprises at least a processor configured to modify content of or content associated with the retrieved first resource, said modifying comprises supplementing said content with additional content.

16. The data processing system of claim 13, wherein the proxy server being adapted to retrieve the first resource via the first associated IP address and to modify the retrieved first resource comprises at least a processor configured to modify content of or content associated with the retrieved first resource, said modifying comprises replacing at least partially said content or at least part of said retrieved content with replacement content.

17. The data processing system of claim 13, wherein the proxy server being adapted to retrieve the first resource via the first associated IP address and to modify the retrieved first resource comprises at least a processor configured to modify content of or content associated with the retrieved first resource, said modifying comprises reformatting the spatial distribution of the content of or associated with the retrieved first resource.

18. The data processing system of claim 13, wherein the proxy server being adapted to retrieve the first resource via the first associated IP address and to modify the retrieved first resource comprises at least a processor configured to modify content of or content associated with the retrieved first resource, said modifying comprises reformatting the temporal presentation of the content of or associated with the retrieved first resource.

19. The data processing system of claim 13, wherein the proxy server being adapted to retrieve the first resource via the first associated IP address and to modify the retrieved first resource comprises at least a processor configured to substitute at least part, or the whole, of a retrieved resource with a replacement resource.

20. The data processing system of claim 13, further comprising a processor configured to, or comprising means to, perform one or more than one operation associated with a retrieved resource.

21. The data processing system of claim 20, wherein the processor configured to perform one or more than one operation associated with a retrieved resource is configured to process one or more than one retrieved instruction associated with the retrieved resource.

22. The data processing system of claim 20, wherein the processor configured to perform one or more than one operation associated with a retrieved resource is configured to influence execution of one or more than one retrieved instruction associated with the retrieved resource.

23. The data processing system of claim 22, wherein the processor configured to influence execution of one or more than one retrieved instruction associated with the retrieved resource is configured to:
a. delete the one or more than one instruction;
b. prevent execution of the one or more than one instruction;
c. replace the one or more than one instruction with an alternative instruction; or
d. supplement the one or more than one instruction with at least one additional instruction.

24. The data processing system of claim 13, wherein the content of or content associated with the retrieved first resource comprises at least one or more of
a. data of or associated with a web-page, and
b. code of or associated with a web-page.
